(19) United States
(12) Patent Application Publication
(10) Pub. No.: US 2026/0254772 A1
(43) Pub. Date: Aug. 27, 2026

(54) Peer port telemetry

(71) Applicant: Mellanox Technologies, Ltd., Yokneam (IL)

(72) Inventors: Ayal Lior, Kiryat Ono (IL); Ziv Battat, Tel Aviv (IL); Ortal Bashan, Tel Aviv (IL)

(21) Appl. No.: 19/443,108

(22) Filed: Jan. 8, 2026

Related U.S. Application Data
(60) Provisional application No. 63/762,652, filed on Feb. 25, 2025.

(51) Int. Cl. H04L 49/111

(52) U.S. Cl. CPC H04L 49/111

(57) ABSTRACT

The present disclosure provides a switch comprising a plurality of switch ports for connection via network links to peer ports of one or more hosts, and a controller. The controller reads via the switch ports from the peer ports telemetry data including performance metrics of the peer ports and reports the telemetry data to a management server. The switch may read the telemetry data using in-band messages transmitted over the network links.

### CROSS-REFERENCE TO RELATED APPLICATION

This application claims the benefit of U.S. Provisional Patent Application 63/762,652, filed February 25, 2025, which is incorporated herein by reference.

### FIELD

The present disclosure relates to network telemetry in data center environments, and more particularly, but not exclusively, to a system and method for collecting peer port telemetry data from host devices using switch-initiated in-band messaging.

### BACKGROUND

Network telemetry refers to the collection and analysis of data about the performance and behavior of network devices and systems. It involves gathering metrics such as traffic patterns, latency, packet loss, and device health to provide visibility into network operations. This data helps network administrators monitor performance, troubleshoot issues, and optimize network configurations.

U.S. Patent 10,530,673, whose disclosure is incorporated herein by reference, describes a communication apparatus with multiple ports for transmitting and receiving data packets. The apparatus includes a processor configured to receive telemetry data from an unmanaged neighboring device via a link-layer protocol. The processor aggregates this telemetry data in memory and reports it to a network management station using a network-layer protocol. The telemetry data may include counts of transmitted/received packets, discarded packets, error counts, and queue lengths.

U.S. Patent 11,558,310, whose disclosure is incorporated herein by reference, discloses a network device with ports for connecting to a communication network. The device receives data packets and probe packets addressed to a common output port. Data packets are stored in one queue while probe packets are stored in a separate, higher-priority queue. The device produces telemetry data based on the processing path of the data packets and modifies the probe packets to carry this telemetry data. The probe packets are transmitted at a higher priority than the data packets to enable low-latency delivery of the telemetry information.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

An aspect of the present disclosure provides a switch, which includes a plurality of switch ports for connection via network links to peer ports of one or more hosts. The switch also includes a controller to read via the switch ports from the peer ports telemetry data including performance metrics of the peer ports and to report the telemetry data to a management server.

Another aspect of the present disclosure provides a method, which includes receiving, by a switch, from peer ports of one or more hosts via switch ports of the switch, telemetry data including performance metrics of the peer ports. The method also includes reporting the telemetry data to a management server.

A further aspect of the present disclosure provides a system, which includes a switch including a plurality of switch ports, one or more hosts, each host including one or more peer ports connected to the switch ports via network links, and a management server. The switch receives telemetry data from the peer ports of the one or more hosts via the switch ports, including performance metrics of the peer ports, and reports the telemetry data to the management server.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a block diagram, which schematically illustrates a computer system with multiple hosts, switches, and a management server, according to aspects of the present disclosure.

FIG. 2 is a block diagram showing details of a host and connected switches in the system of FIG. 1, according to an aspect of the disclosure.

FIG. 3 is a flowchart that schematically illustrates a method for endpoint discovery and telemetry, according to an aspect of the disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

In modern data center environments, cloud service providers (CSPs) face significant challenges in obtaining comprehensive visibility into network performance and fault conditions. While CSPs typically have access to telemetry data from switch operating systems, there is a critical gap in visibility on the host side, for example regarding performance of Host Channel Adapters (HCAs) or Graphics Processing Units (GPUs). This lack of visibility stems from the fact that host-side software is often controlled by tenants and is not accessible to the CSP.

The inability to access host-side telemetry data creates a blind spot in network management and troubleshooting efforts. CSPs may struggle to identify performance bottlenecks, diagnose faults, or optimize network configurations without a complete picture of the network's state, including the condition of host-side ports and links.

To address this challenge, there is a need for a solution that allows CSPs to gather telemetry data from the peer side of network links, specifically from host ports connected to network switches. Such a solution would enable CSPs to obtain valuable information about traffic patterns, error rates, and other performance metrics directly from the host side, without requiring access to tenant-controlled software.

The present disclosure provides an approach to solving this problem by enabling switches to read telemetry data from directly attached peer ports, such as HCA or GPU ports. The counters and telemetry communications are handled on the host side by firmware running on a dedicated processor, without involvement of the host operating system. The switches may expose the peer port data to the management server using the same standard telemetry protocols, such as gNMI, that are already in use for switch telemetry and configuration control.

The present methods allow for the collection of important performance metrics and fault indicators from the host side, bridging the visibility gap that CSPs currently face. They enable a network management server to identify and isolate the specific ports and links where faults occur. By implementing these approaches, CSPs may gain valuable insights into host-side network performance and conditions, enabling more effective management, troubleshooting, and optimization of their data center networks.

In some cases, switches may use extensions to existing protocols or proprietary protocols to gather peer port data. For example, the Link Layer Discovery Protocol (LLDP) may be extended to support the exchange of telemetry information. Alternatively, a proprietary Ethernet protocol may be developed for this purpose.

When using LLDP extensions or proprietary protocols, it may be necessary for the switch to negotiate with the far end (i.e., the host port) to determine whether it supports the extended functionality. This negotiation process ensures compatibility and allows for graceful fallback to standard operation when the extended features are not supported.

To structure the telemetry data within LLDP messages, Type-Length-Value (TLV) fields may be used. Each type of telemetry information, such as traffic counters, error rates, or physical layer statistics, may be assigned a specific TLV. These TLVs may be included after the generic LLDP header, allowing for a flexible and extensible format for transmitting telemetry data.

In other implementations, Management Datagram (MAD) packets may be utilized to convey telemetry data between the peer ports and the switch. MADs, which are typically associated with InfiniBand and NVLink protocols, may provide a flexible mechanism for exchanging management and control information, including telemetry data. The switch may send MAD packets to query specific telemetry information from the peer ports, such as traffic statistics, error counters, or link health indicators. The peer ports may respond with MAD packets containing the requested telemetry data, allowing the switch to collect detailed performance metrics without relying on higher-level protocols or host-side software access.

The ability to collect important performance metrics and fault indicators from the host side bridges the visibility gap that CSPs currently face. This comprehensive view of network performance, including both switch-side and host-side data, may enable more accurate identification of performance bottlenecks, faster diagnosis of faults, and improved optimization of network configurations.

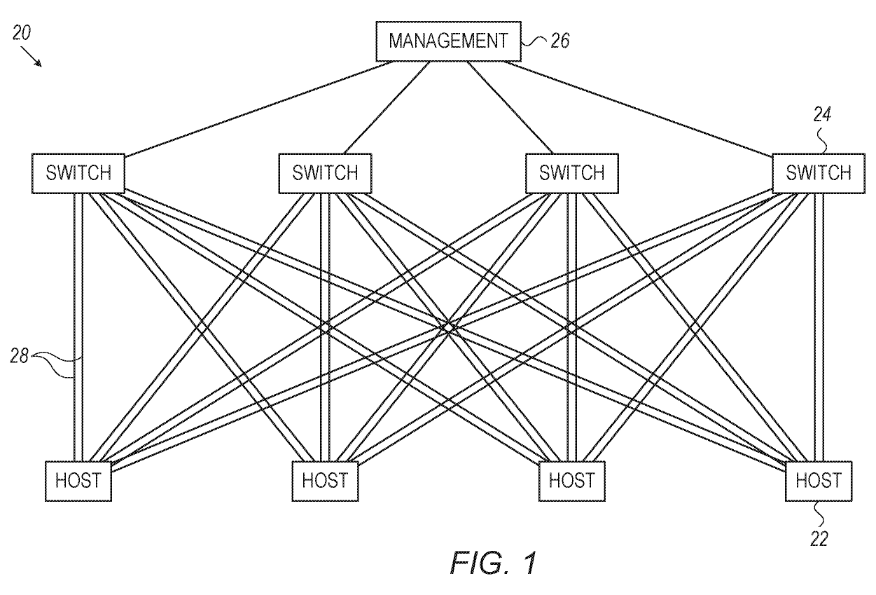

FIG. 1 illustrates a computer system 20 comprising multiple hosts 22, switches 24, and a management server 26 interconnected by network links 28. The computer system 20 in the pictured example includes four switches 24, which connect to four hosts 22, such as general-purpose servers or special-purpose processors, such as GPUs or other computational accelerators. In practical applications, such as data center networks, the computer system 20 may include a much larger number of switches 24 and hosts 22.

The network links 28 connect each host 22 to multiple switches 24 in a full mesh pattern. This mesh interconnection between the hosts 22 and switches 24 provides multiple communication paths between components, thus maximizing the available communication bandwidth and choice of possible communication paths within the network.

The switches 24 connect to the management server 26 through in-band or sideband links, to transmit telemetry data from the switches 24 to the management server 26 and receive configuration commands from the management server 26. These functions may be carried out under the control of the switch operating system and may be programmed by the network service provider. Although the management server 26 is shown in FIG. 1 as a local part of the computer system 20, the switches 24 may alternatively communicate with a remote management server or management function; and the term “management server” as used in the present description and in the claims should be understood as referring to any management entity suitable for communicating with the switches 24 in this capacity.

The management server 26 may not communicate directly with the hosts 22, which may run their own operating systems and application software, programmed by users of the hosts 22. Instead, the management server 26 may receive telemetry data from the hosts 22 via the switches 24 to which the hosts 22 are connected. This arrangement may enable the management server 26 to monitor and manage network communications throughout the computer system 20.

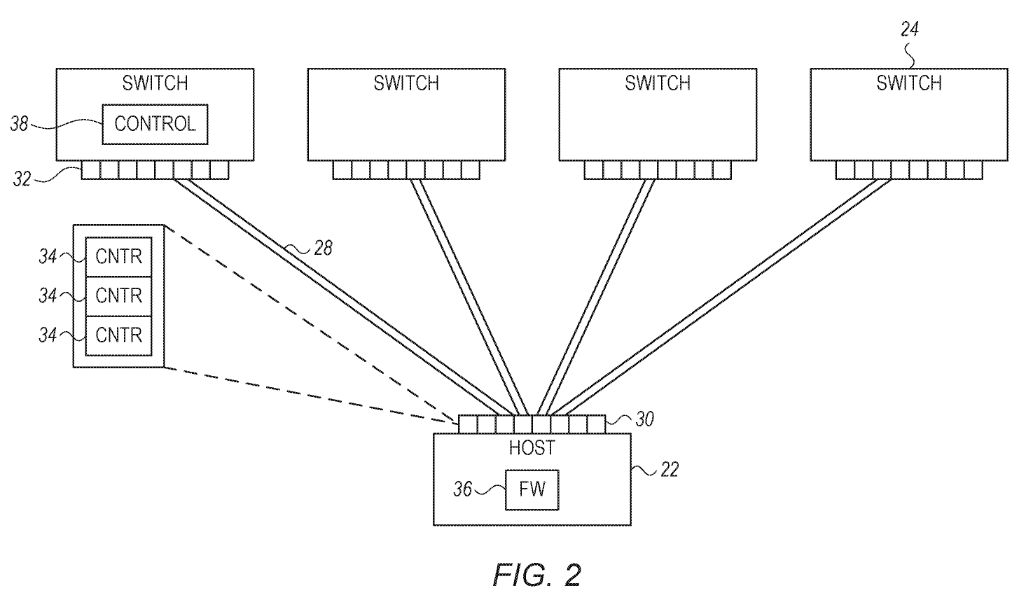

FIG. 2 shows details of one of the hosts 22 and the switches 24 to which the host 22 is connected in computer system 20 (FIG. 1). The host 22 comprises multiple host ports 30, for example ports of a host channel adapter (HCA) or other network interface controller (NIC), which are connected to switch ports 32 in multiple switches 24 through respective network links 28. The host 22 incorporates a processor 36, which may collect telemetry data from host ports 30 under control of firmware (FW), independently from the host operating system.

Each host port 30 comprises multiple counters 34, which monitor various operational parameters. The counters 34 may track various metrics including traffic and error statistics. The processor 36 may manage the collection and processing of telemetry data from the counters 34.

The network links 28 connect the switch ports 32 to the host ports 30, enabling communication between the switches 24 and the host 22. Each switch 24 includes a switch controller 38, which may run a switch operating system that includes telemetry functions. The architecture may allow the switch controller 38 to read telemetry data both from the switch ports 32 and from their directly attached peer host ports 30 through in-band messages, which may be handled by processor 36. Each switch 24 receives and reports telemetry data with respect to the specific peer host ports 30 to which it is connected. 1. General identifiers – port number, address, networking entity ID.
2. Traffic counters – transmitted (TX) bytes, TX packets, TX drops, received (RX) bytes, RX packets, RX drops.
3. State information – physical state, logical state, admin state, last error type, last error timestamp.
4. Physical layer (PHY) counters – bit error rate (BER) measurement, forward error correction (FEC) histogram counters.

The host 22 may include firmware, running on the processor 36, which responds to telemetry request messages from the switch 24. This firmware may provide a list of counters for the specific port in response to the in-band messages.

The switch controller 38 may keep telemetry replies in a Networking Operating System (NVOS) database. The switch controller 38 may report the telemetry data to the management server 26 (FIG. 1) using a gRPC Network Management Interface (gNMI) protocol. Alternatively, the switch controller 38 may report the telemetry data to the management server 26 using an OTLP protocol, as defined by the Open Telemetry forum. In some cases, the switch controller 38 may report the telemetry data using an OpenConfig data model, which may be extended to include a peer-port branch for reporting the telemetry data.

This arrangement may allow the management server 26 to obtain comprehensive telemetry data from both the switches 24 and the hosts 22, enabling effective monitoring and management of the computer system 20.

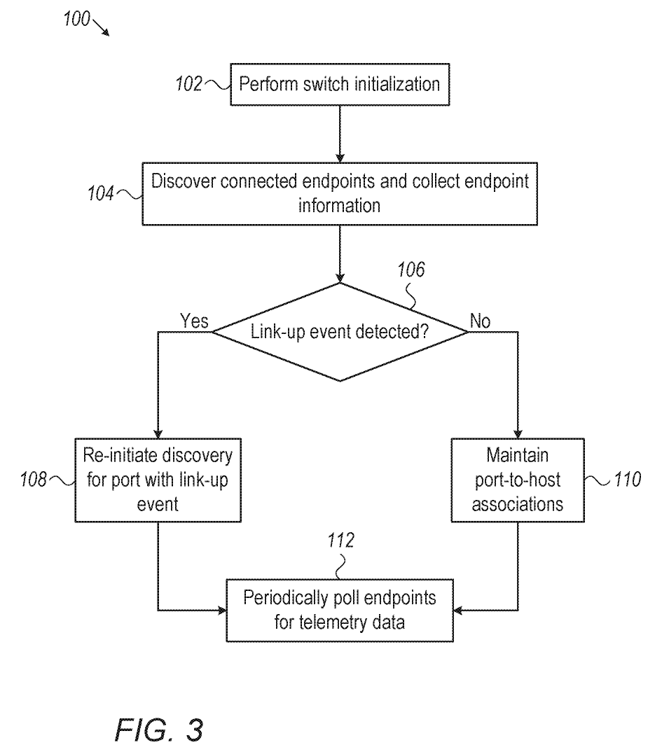

FIG. 3 is a flowchart that schematically illustrates a method 100 for switch endpoint discovery and telemetry. The method 100 begins with an initialization step 102, at which the switches 24 in a network, such as the network 20, begin the process of collecting telemetry data. The switches 24 proceed to a discovery step 104, at which connected endpoints are discovered and endpoint information is collected. At this step, each switch discovers all its directly connected end-points, such as hosts 22, as well as the ports 32 to which they are connected, as well as the end-point addresses, such as an InfiniBand local identifier (LID) or an Ethernet MAD address. On this basis, the switch creates a host association for each port.

Following this initial discovery, the switches 24 check for link-up events, at a link-up detection step 106. If a link-up event is detected on a given port 32, the switch 24 reinitiates discovery for this port, at a discovery triggering step 108, and updates the port-to-host association as needed. Otherwise, the switch maintains the existing port-to-host association, at a maintenance step 110.

Periodically, each switch 24 polls its associated hosts 22 for telemetry data, at a polling step 112. As explained earlier, the telemetry data may include the values of various traffic counters and PHY counters 34 maintained by host ports 30, as well as port state information.

A number of implementations have been described. Nevertheless, it will be understood that various modifications may be made without departing from the spirit and scope of the disclosure. Accordingly, other implementations are within the scope of the following claims.

1. A switch comprising:
a plurality of switch ports for connection via network links to peer ports of one or more hosts; and
a controller to read via the switch ports from the peer ports telemetry data including performance metrics of the peer ports and to report the telemetry data to a management server.

2. The switch of claim 1, wherein the controller is to read the telemetry data using in-band messages transmitted over the network links.

3. The switch of claim 2, wherein the in-band messages comprise Management Datagram (MAD) packets for InfiniBand or NVLink protocols.

4. The switch of claim 2, wherein the in-band messages comprise Ethernet packets.

5. The switch of claim 1, wherein the telemetry data comprises at least one of: traffic counters, error counters, and state information.

6. The switch of claim 1, wherein the controller is to report the telemetry data to the management server using a gNMI (gRPC Network Management Interface) protocol or an Open Telemetry Protocol (OTLP).

7. The switch of claim 6, wherein the controller is to report the telemetry data using an OpenConfig data model, which is extended to include a peer-port branch for reporting the telemetry data.

8. A method comprising:
receiving, by a switch, from peer ports of one or more hosts via switch ports of the switch, telemetry data including performance metrics of the peer ports; and
reporting the telemetry data to a management server.

9. The method of claim 8, wherein receiving the telemetry data comprises receiving the telemetry data using in-band messages.

10. The method of claim 9, wherein the in-band messages comprise Management Datagram (MAD) packets for InfiniBand or NVLink protocols.

11. The method of claim 9, wherein the in-band messages comprise Ethernet packets.

12. The method of claim 8, wherein the telemetry data comprises at least one of: traffic counters, error counters, and state information.

13. The method of claim 8, wherein reporting the telemetry data comprises reporting the telemetry data using a gNMI (gRPC Network Management Interface) protocol or an Open Telemetry Protocol (OTLP).

14. The method of claim 13, further comprising extending an OpenConfig data model to include a peer-port branch for reporting the telemetry data.

15. The method of claim 8, wherein receiving the telemetry data comprises associating each port of the switch with a corresponding peer port of a given host, and each port periodically polling the corresponding peer port.

16. The method of claim 15, wherein associating each port comprises detecting a link-up event at a given port, and updating an association between the given port and the corresponding peer port in response to the detected link-up event.

17. A system comprising:
a switch comprising a plurality of switch ports;
one or more hosts, each host comprising one or more peer ports connected to the switch ports via network links; and
a management server,
wherein the switch is to receive, from the peer ports of the one or more hosts via the switch ports, telemetry data including performance metrics of the peer ports and to report the telemetry data to the management server.

18. The system of claim 17, wherein the one or more hosts are to collect and report the telemetry data under control of firmware running on a dedicated processor, without involvement of a host operating system.

19. The system of claim 17, wherein the switch is to receive the telemetry data using in-band messages transmitted over the network links.

20. The system of claim 17, wherein the telemetry data comprises at least one of: traffic counters, error counters, and state information.
